(19) United States
(12) Patent Application Publication
(10) Pub. No.: US 2017/0085296 A1
(43) Pub. Date: Mar. 23, 2017

(54) NEAR FIELD COMMUNICATION BUILT-IN GARMENT ACCESSORY

(71) Applicant: Great Giant Fibre Garment Co., Ltd., Taipei City (TW)

(72) Inventor: KUNG JEN HSU, Taipei City (TW)

(21) Appl. No.: 15/365,173

(22) Filed: Nov. 30, 2016

Related U.S. Application Data
(63) Continuation-in-part of application No. 15/089,130, filed on Apr. 1, 2016.

(30) Foreign Application Priority Data
Apr. 14, 2015 (TW) 104205569

(51) Int. Cl. H04B 5/00; A41D 27/08; A44B 1/08; A44B 1/20; G06K 7/10; A44B 19/24

(52) U.S. Cl. CPC H04B 5/0031; G06K 7/10297; A44B 19/24; A44B 1/08; A44B 1/20; A41D 27/08

(57) ABSTRACT

The present invention provides a near field communication built-in garment accessory and the method for manipulating the same. The near field communication built-in garment accessory comprises a near field communication module (NFC module) located at a position of the garment accessory to communicate with an electronic device to transfer data between the electronic device and the NFC module. In addition, the garment accessory comprises a main body, a covering member to integrate with the main body, and the NFC module positioned between a space created by integration of the main body and the covering member wherein the accessory is water proof.

### BACKGROUND OF THE INVENTION

a. Field of the Invention

The invention relates to a near field communication (NFC) built-in garment accessory, such as buttons, zipper heads, patches, prints, embroidered sheets, to bi-directionally communicate with electronic devices, such as smart phones, tablets, pads and the method for manipulating the same.

b. Description of the Related Art

Near field communication (NFC) is short-range high frequency wireless communication technology to allow non-contact point-to-point data transfer between electronic devices. The NFC-related products are quite diversified in daily life and there are a lot of patented NFC derived products, such as the following examples.

According to TW M496812, a door access control device comprising a NFC unit and a fingerprint recognition unit and a management system to communicate with the door access control device are disclosed. A user can use his finger to induce the door access control device to sense the fingerprint to perform identity recognition as management and record for accessing the door.

According to TW M494970, an intelligent timing device is disclosed. The communication between the NFC modules of the intelligent timing device and a second intelligent device can be used to wirelessly control and monitor various activities of the intelligent timing device through the second intelligent device.

According to TW M493827, a finger ring comprising a NFC chip is disclosed where the antenna is spirally wrapped on the NFC chip to form a NFC module and the module is accommodated inside the finger ring. After the finger ring is set to a finger, the sensing range of the NFC chip is reduced to the lowest possible range to avoid illegal accessing the data stored in the NFC module.

According to TW M483614, a wireless communication alert device comprising a portable mobile device built-in with a NFC alert module is disclosed. The NFC alert module comprises a first sensor, a display unit and a transmitter where the first sensor detects a sensing device built-in with a second sensor and a speaker. When the first sensor detects the second sensor or the second sensor is moved to be away from the detectable range of the first sensor, an alert is sounded from the speaker.

According to the enormous patented applications related to NFC modules, the inventor considers the combination of NFC with garment industry is possible and mature technologically. Not only can the garment have the added value but also have a playful look. For example, a gift giver buys an inexpensive shirt as a holiday gift but puts the blessing picture or video to the NFC module on the shirt through the NFC device of the smart phone and the gift recipient can play and receive the blessing picture or video from NFC module on the shirt through the NFC device of his own smart phone. Thus, the blessing from the gift giver can be vividly presented to the recipient to add up the value of the shirt. Certainly, the value of the shirt is much beyond the purchased price. Besides, the garment maker can build the data base to connect with the purchaser through the NFC module on the garment to use as the discount basis or membership point accumulation basis. Therefore, the garment built-in with NFC, which may be called “intelligent clothing” or “iclothing”, has immeasurable future of development.

However, although the concept of intelligent clothing is very constructive, the production cost of the garment is ought to be reduced in order to promote the popularity. Therefore, the function and cost both are important to make the concept successful.

### BRIEF SUMMARY OF THE INVENTION

In light of the above background, in order to fulfill the requirements of the industry, based on the experience of garment manufacture, the inventor believe the most effective way is to mount the NFC device on a garment accessory, such as buttons, zipper heads, patches, prints, embroidered sheets, because garment accessories can be made outside garment factories without affecting the operation of a garment production line. As long as the garment accessory is built-in with the NFC module, the garment is equipped with NFC once the garment accessory is attached.

However, when the NFC module is set to a garment accessory, the NFC module commonly purchased from commercialized products has large volume and is difficult to fit into the limited space of the garment accessory. Besides, the garment accessory should be water proof and impact resistant. The garment accessory is water proof to prevent the NFC chip and antenna from being short-circuited or malfunctioned. The garment accessory is designed to be impact resistant to avoid damage of the NFC module. Particularly, according the design of the present invention, a NFC module including a NFC chip and an antenna is set in a compact garment accessory, for example, a button with a diameter of 1 cm or less than 1 cm, or a zipper head with a length of 1 cm or less than 1 cm.

one object of the invention provides a near field communication built-in garment accessory to increase the added value of a commodity. Other objects are to supply more and detailed product information and to communicate with electronic devices, such as smart phones, with a NFC functionality to interchange data.

In order to achieve the above objects, according to the present invention, a near field communication built-in garment accessory, having a near field communication module (NFC module) located at a position of the garment accessory to communicate with an electronic device to transfer data between the electronic device and the NFC module and comprising a main body, a covering member to integrate with the main body and the NFC module positioned between a space created by integration of the main body and the covering member wherein the accessory is water proof; wherein the NFC module comprises a NFC chip and an antenna; the antenna is positioned surrounding the periphery of the space; the main body and the covering member are integrated by an adhesive or through high frequency welding; the NFC module has a memory and has a function of encryption to determine whether the data stored in the NFC is accessible or not.

According to the garment accessory of the present invention, the garment accessory can be for example a button, a zipper head, a patch, a print, an embroidered sheet, etc. The garment accessory can be set or mounted to a garment by sewing, thermal transfer, clipping and so forth. The integration of the NFC module with the garment accessory can provide a variety of information to a user, such as materials, washing instructions, manufacturing location, manufacturer, etc. In addition, any words or voices a user wishes to add can be stored in the NFC module on the garment accessory and accessed interactively through an app or accessed by request.

Moreover, the present invention also discloses a method for manipulating data stored in a near field communication built-in garment accessory, having a near field communication module (NFC module) located at a position of the garment accessory to communicate with an electronic device to transfer data between the electronic device and the NFC module and comprising a main body, a covering member to integrate with the main body and the NFC module positioned between a space created by integration of the main body and the covering member wherein the accessory is water proof; wherein the NFC module comprises a NFC chip and an antenna; the antenna is positioned surrounding the periphery of the space; the main body and the covering member are integrated by an adhesive or through high frequency welding; the NFC module has a memory and has a function of encryption to determine whether the data stored in the NFC is accessible or not, the method comprises the following steps: providing an electronic device supporting near field communication or a near field communication reading electronic device; having the near field communication built-in garment accessory be approached to the electronic device within a distance less than 30 mm; reading data stored in the near field communication built-in garment accessory by the electronic device wherein the data include one item selected from the group consisting of the following or combination thereof: cloth care instruction, brand name authentication information, owner identification, contact information, medical care alert information, cloth size, production history, membership, and uniform resource locator (URL); and processing the data by the electronic device through providing a process selection menu including choices of starting a lottery, reading cloth related information, going to a private URL and going to a public URL wherein the cloth related information includes one item selected from the group consisting of the following or combination thereof: cloth care instruction, brand name authentication information, owner identification, contact information, medical care alert information, cloth size, production history, membership.

According to the manipulating method of the present invention, the care instruction and material information of the garment can be shown on a display of a NFC reading device, such as a mobile phone which supports NFC and the care instruction and material information of the garment have no need to be printed or stitched a small tag on the garment to cause wearing discomfort. In addition, interactive procedures with the garment accessory can be conducted to create extra values, such as authenticating a brand name, providing owner information and providing medical care alert information. According to the manipulating method of the present invention, a lottery can be executed to give extra perks, such as a discount percentage, a gift, a discount coupon, a membership cumulative point and besides the user can be directed to an online store (E-store), a social website (Facebook or the like) or a video playing platform (YouTube or the like) for private or public video (music) clips for getting more entertainment effect. When the user is directed to an online store (E-store), the store can process the information and the style of the garment accessory to display a specific web page to match with or relate to the accessory. Other objectives, features and advantages of the invention will be further understood from the further technological features disclosed by the embodiments of the invention wherein there are shown and described preferred embodiments of this invention, simply by way of illustration of modes best suited to carry out the invention.

### BRIEF DESCRIPTION OF THE DRAWINGS

FIG. 1 shows a schematic diagram illustrating a near field communication built-in garment accessory as a thick-type button according to one embodiment of the invention.

FIG. 2 shows a cross-sectional schematic diagram illustrating a near field communication built-in garment accessory as a thin-type button according to one embodiment of the invention.

FIG. 3 shows a cross-sectional schematic diagram illustrating a near field communication built-in garment accessory as a zipper head according to one embodiment of the invention.

FIG. 4 shows a cross-sectional schematic diagram illustrating a near field communication built-in garment accessory as a patch according to one embodiment of the invention.

FIG. 5 shows a schematic diagram illustrating an exploded perspective view of a near field communication built-in garment accessory as a thin-type button according to another embodiment of the invention.

FIG. 6 shows a schematic diagram illustrating an exploded perspective view of the thin-type button of FIG. 5 before the NFC module is mounted.

FIG. 7 shows a schematic diagram illustrating a near field communication built-in garment accessory as a zipper head according to another embodiment of the invention where (a) shows a top view; (b) shows a bottom view; and (c) shows a side view.

FIG. 8 shows a schematic diagram illustrating various types of integration between a main body and a covering member of a near field communication built-in garment accessory according to one embodiment of the invention where (a) longitudinal integration; (b) lateral integration; and (c) spiral integration.

FIG. 9 shows a flow chart illustrating the method for manipulating data stored in a near field communication built-in garment accessory according to one embodiment of the invention.

FIG. 10 shows a schematic diagram illustrating a data input or information reading selection menu used in the manipulating method according to one embodiment of the invention.

FIG. 11 shows a schematic diagram illustrating a process selection menu used in the manipulating method according to one embodiment of the invention.

FIG. 12 shows a schematic diagram illustrating a display screen when “lottery” button is pressed.

FIG. 13 shows a schematic diagram illustrating a display screen when “E-store”, “private URL” or “public URL” button is pressed.

### DETAILED DESCRIPTION OF THE INVENTION

In the following detailed description of the preferred embodiments, reference is made to the accompanying drawings which form a part hereof, and in which are shown by way of illustration specific embodiments in which the invention may be practiced. The drawings are only schematic and the sizes of components may be exaggerated for clarity. It is to be understood that other embodiments may be utilized and structural changes may be made without departing from the scope of the invention. Also, it is to be understood that the phraseology and terminology used herein are for the purpose of description and should not be regarded as limiting. The common structures and elements that are known to everyone are not described in details to avoid unnecessary limits of the invention. Some preferred embodiments of the present invention will now be described in greater detail in the following.

According to a first embodiment of the invention, a near field communication (NFC) built-in garment accessory is disclosed. The NFC built-in garment accessory comprises a near field communication module (NFC module) located at a position of the garment accessory to communicate with an electronic device to transfer data between the electronic device and the NFC module. In addition, the garment accessory comprises a main body, a covering member to integrate with the main body, and the NFC module positioned between a space created by integration of the main body and the covering member. The garment accessory is water proof. The garment accessory can be for example a button, a zipper head, a patch, a print, an embroidered sheet, etc. The garment accessory can be set or mounted to a garment by sewing, thermal transfer, clipping and so forth.

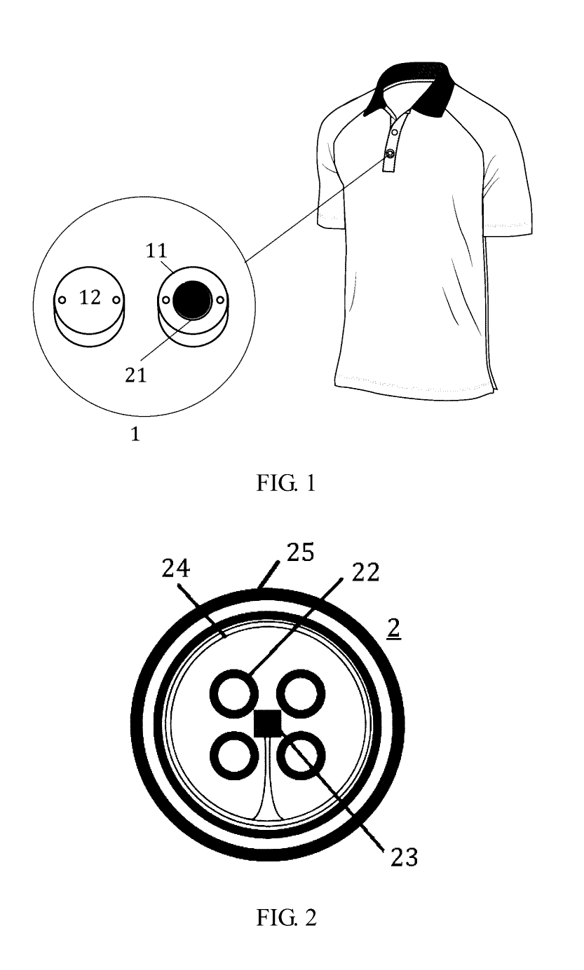

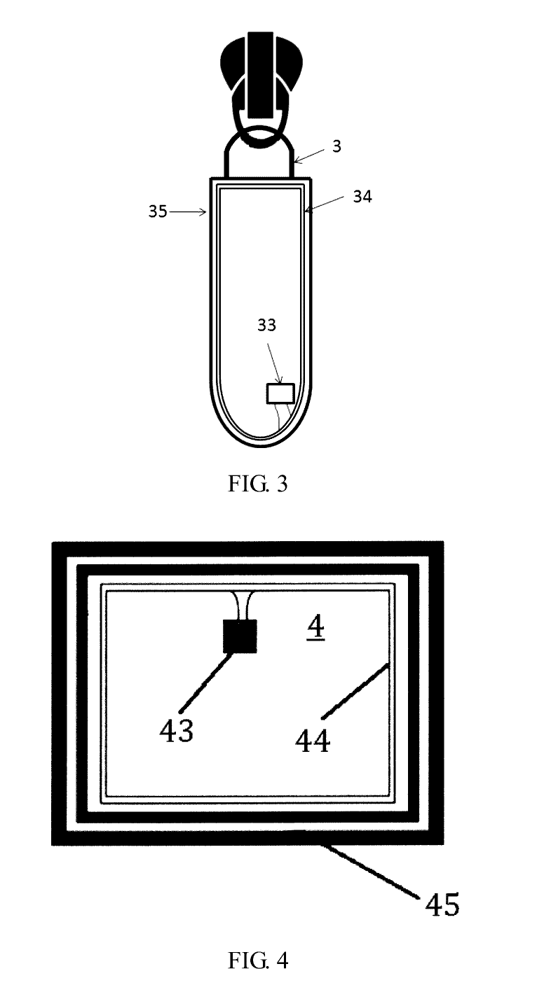

Please refer to FIG. 1˜FIG. 4. FIG. 1˜FIG. 4 show the garment accessory as a thick-type button 1, a thin-type button 2, a zipper head 3, and a patch 4, respectively. As shown in FIG. 1, the thick-type button 1 comprises a main body 11, a covering member 12 and a NFC module set in a groove 21. As shown in FIG. 2, the thin-type button 2 comprises a main body 25, a covering member, a NFC chip 23, an antenna 24, and a plurality of though holes 22 which penetrate the main body 11 and the covering member 12. In FIG. 2, the covering member is not shown because of the cross-sectional view and has a shape being the mirror image of the main body 25. As shown in FIG. 3, label “33” represents a NFC chip, label “34” represents an antenna, label “35” represents a main body. As shown in FIG. 4, label “43” represents a NFC chip, label “44” represents an antenna, label “45” represents a main body.

The method of integration of the main body and the covering member can be to combine them for example (1) by a joint member; (2) by an adhesive or bonding agent; (3) by high frequency welding, particularly, supersonic welding; (4) by binding the joggle portions of the main body and the covering member where the joggle portions of the main body and the covering member are formed in advance into various shapes; (5) by injection molding (injection molding can form the main body and the covering member into one piece and the NFC can be wrapped by a protect plastic film or films before processing). The integration of the main body and the covering member is not limited to above methods and also not limited to the lateral integration shown in FIG. 1˜FIG. 4. As shown in FIG. 8, the integration between a main body and a covering member can be (a) longitudinal integration; (b) lateral integration; and (c) spiral integration. Besides, the shapes of the main body and the covering member are not limited to a plate-like shape and can be any shape as long as they are fitted to integrate to become water proof.

Moreover, after the joint member is used to combine the main body and the covering member, an adhesive or bonding agent or through high frequency welding can be used to further secure the integration of the main body and the covering member. Or, before the joint member is used to combine the main body and the covering member, the surface or location of the joint member can be applied with an adhesive or bonding agent to assist the integration. Therefore, a garment accessory having excellent mechanical strength and water proof can be obtained. One of the above mentioned integration methods or the combination thereof can be used to integrate the main body and the covering member of the garment accessory and the garment accessory can be various types, such as thick buttons, thin buttons, zipper heads, patches. For example, the joggle portions of the main body and the covering member can be applied with an adhesive or bonding agent and then bound together to improve the water proof function. The material to be used as the main body and the covering member can be plastics, such as acrylic resin, polycarbonate resin, acrylonitrile butadiene styrene (ABS) resin, composite of resin and fiber and multilayered material.

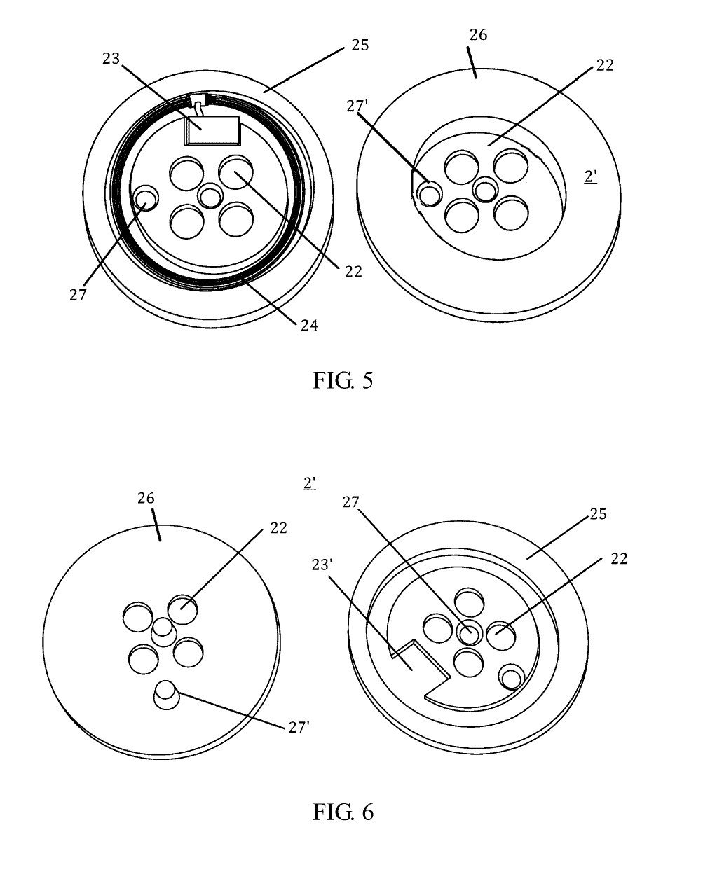

FIG. 5 shows a schematic diagram illustrating an exploded perspective view of a near field communication built-in garment accessory as a thin-type button 2′ according to another embodiment of the invention. FIG. 6 shows a schematic diagram illustrating an exploded perspective view of the thin-type button of FIG. 5 before the NFC module is mounted. In FIG. 5 and FIG. 6, label “23′” represents a groove to accommodate a NFC chip and label “26” represents a covering member and label “27” and “27′” represent positioning members. The positioning member 27 on the main body 25 is two protruding pillars and the positioning member 27′ on the covering member 26 is two pits to be fitted with the positioning member 27. The types of the button are not limited to examples shown in FIG. 2 and FIG. 5 and can be a button having any number of holes or no hole. The button with no hole is, for example, a cuff link or a button with a hook or a pin.

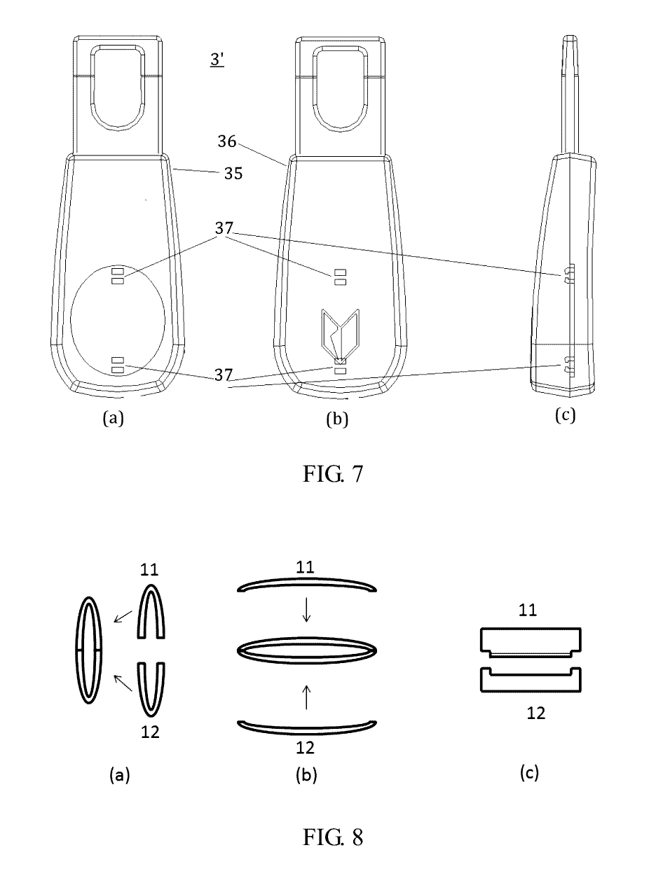

FIG. 7 shows a schematic diagram illustrating a near field communication built-in garment accessory as a zipper head 3′ according to another embodiment of the invention where (a) shows a top view; (b) shows a bottom view; and (c) shows a side view. Label “35” represents a main body, label “36” represents a covering member and label “37” represents a joint member.

The NFC module comprises at least a NFC chip and an antenna. The NFC module is located in a space formed during the integration of the main body and the covering member. The NFC chip can be, for example, a Mifare NFC Classic Tag or other similar chip, such as, but not limited to, NTAG203, NTAG213, NTAG215, NTAG216 or compatible ones. The NFC chip can be located in the center or periphery of the space and the antenna can be wired surrounding the periphery of the space. The NFC chip has a memory to store various data such as material of the garment, washing instruction, production history, etc., and also has a function of encryption to protect the stored data from undesired access.

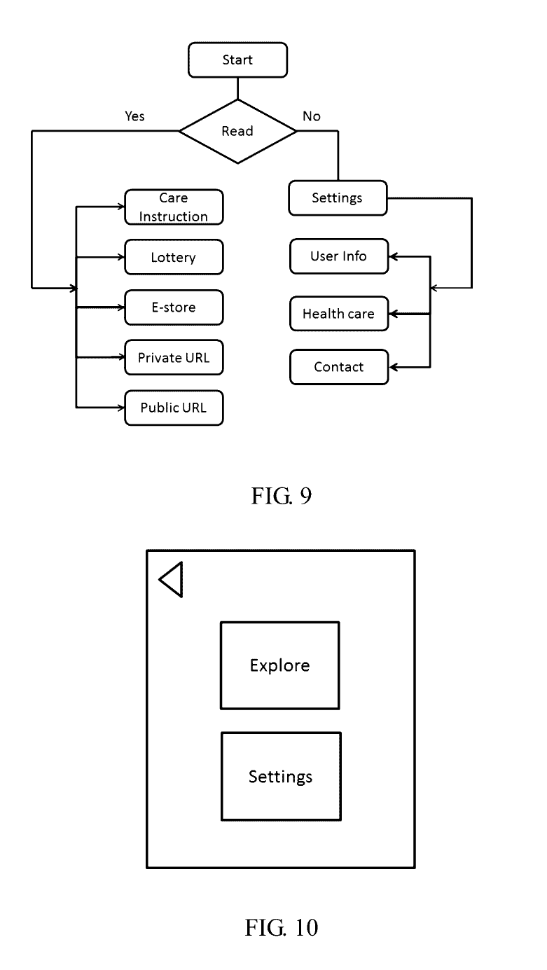

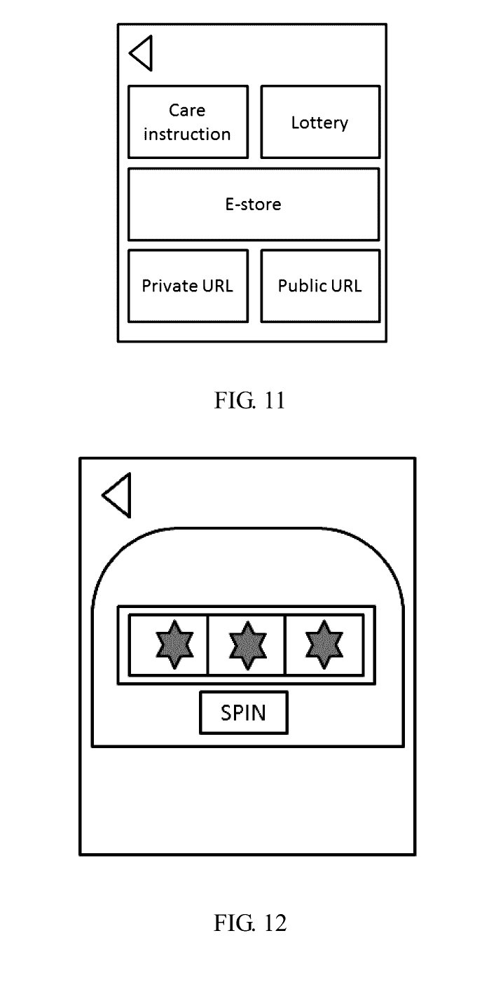

FIG. 9 shows a flow chart illustrating the method for manipulating data stored in a near field communication built-in garment accessory according to one embodiment of the invention. The method comprises the following steps: (1) providing an electronic device supporting near field communication or a near field communication reading electronic device; (2) having the near field communication built-in garment accessory be approached to the electronic device within a distance less than 30 mm; (3) reading data stored in the near field communication built-in garment accessory by the electronic device; and (4) processing the data by the electronic device through providing a process selection menu. FIG. 10 shows a schematic diagram illustrating a data input or information reading selection menu used in the manipulating method. As shown in FIG. 10, a menu including “Explore” and “Settings” is shown. If data are to be written, the process flow goes to the right-hand side steps of FIG. 9 to display “settings” to execute data input where the data may include “care instruction”, “health care”, and/or “contact”, etc. Specifically, the care instruction includes, for example, washing instruction, manufacturing country, manufacturer contact information, fabric content, and so forth. The health care includes, for example, the patient's information needed in case of emergency, such as patient's name, drug instruction, medical doctor. The contact includes, for example, names and phone numbers in case of emergency or loss. In addition, the data may include cloth size for inventory purpose, production history, membership, and uniform resource locator (URL); and processing the data by the electronic device through providing a process selection menu including choices of starting a lottery, reading cloth related information, going to a private URL and going to a public URL wherein the cloth related information includes one item selected from the group consisting of the following or combination thereof: cloth care instruction, brand name authentication information, owner identification, contact information, medical care alert information, cloth size, production history, membership. The processing selection menu may include items of, for example. “care instruction”, “E-store”, “Private URL”, and “Public URL”, on the left-hand side of FIG. 9, after reading the data is executed. FIG. 11 shows a schematic diagram illustrating a process selection menu used in the manipulating method according to one embodiment of the invention.

FIG. 12 shows a schematic diagram illustrating a display screen when “lottery” button is pressed. When “lottery” button is pressed or selected, a screen having a “SPIN” button and simulating a slot machine is displayed to conduct a probability experiment for a buyer to receive, for example, a discount percentage, a gift, a discount coupon, a membership cumulative point, or other perks. In this way, the cloth equipped with the accessory according to the present invention can have extra values.

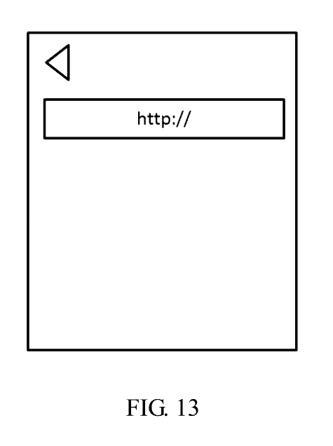

FIG. 13 shows a schematic diagram illustrating a display screen when “E-store”, “private URL” or “public URL” button is pressed. When “E-store”button is pressed or selected, the preset URL is navigated to go to a designated shopping website. In addition, the designated shopping website can categorize the user based on the garment accessory to show specific items related to or matched to the garment accessory or the style of the garment. Therefore, the user has the benefit of efficiently viewing the possibly interest items instead of a standard website homepage. When “private URL” button is pressed or selected, for example, a video clip made by a cloth gift giver can be shown by navigating the private URL stored in advance in the memory of the accessory via the internet. The video clip may be stored on a cloud storage space, such as YouTube, Google drive, icloud, dropbox, etc. Similarly, when “public URL” button is pressed or selected, for example, a public accessible video clip on the public URL is shown. The public URL may be, for example, a link to a social network like “Facebook” or a website like “YouTube”.

The method for manipulating data stored in a near field communication built-in garment accessory according to the present invention can be implemented as a mobile application (APP). The electronic device can be a mobile phone, a portable device, a medical alert device, a loss alert device, or a pad which supports NFC and reads the data stored in a NFC tag.

In conclusion, according to the present invention, a near field communication built-in garment accessory is provided. The garment accessory of the present invention can be various types, such as buttons, zipper heads, and patches to attach to a garment by various methods, such as sewing, thermal transfer, clipping, etc. Besides, the garment accessory can be a print or embroidered sheet made by further thinning the NFC module (thinning the NFC chip and antenna), covering or wrapping the NFC module via a plastic film and finally attaching to a garment by sewing or thermal transfer. The integration of the NFC module with the garment accessory can provide a variety of information to a user, such as materials, washing instructions, manufacturing location, manufacturer, etc. In addition, any words or voices a user wishes to add can be stored in the NFC module on the garment accessory and accessed interactively through an app or accessed by request. The NFC has a memory to store various data such as material of the garment, washing instruction, production history, etc. In addition, the present invention provides a method for manipulating data stored in a near field communication built-in garment accessory. The care instruction and material information of the garment can be shown on a display of a NFC reading device, such as a mobile phone which supports NFC and the care instruction and material information of the garment have no need to be printed or stitched a small tag on the garment to cause wearing discomfort. In addition, interactive procedures with the garment accessory can be conducted to create extra values, such as authenticating a brand name, providing owner information and providing medical care alert information. A lottery can be executed to give extra perks, such as a discount percentage, a gift, a discount coupon, a membership cumulative point and besides the user can be directed to an online store (E-store), a social website (Facebook or the like) or a video playing platform (YouTube or the like) for private or public video (music) clips for getting more entertainment effect. When the user is directed to an online store (E-store), the store can process the information and the style of the garment accessory to display a specific web page to match with or relate to the accessory.

The foregoing description of the preferred embodiments of the invention has been presented for purposes of illustration and description. It is not intended to be exhaustive or to limit the invention to the precise form or to exemplary embodiments disclosed. Accordingly, the foregoing description should be regarded as illustrative rather than restrictive. Obviously, many modifications and variations will be apparent to practitioners skilled in this art. The embodiments are chosen and described in order to best explain the principles of the invention and its best mode practical application, thereby to enable persons skilled in the art to understand the invention for various embodiments and with various modifications as are suited to the particular use or implementation contemplated. It is intended that the scope of the invention be defined by the claims appended hereto and their equivalents in which all terms are meant in their broadest reasonable sense unless otherwise indicated. Therefore, the term “the invention”, “the present invention” or the like does not necessarily limit the claim scope to a specific embodiment, and the reference to particularly preferred exemplary embodiments of the invention does not imply a limitation on the invention, and no such limitation is to be inferred. The invention is limited only by the spirit and scope of the appended claims. The abstract of the disclosure is provided to comply with the rules requiring an abstract, which will allow a searcher to quickly ascertain the subject matter of the technical disclosure of any patent issued from this disclosure. It is submitted with the understanding that it will not be used to interpret or limit the scope or meaning of the claims. Any advantages and benefits described may not apply to all embodiments of the invention. It should be appreciated that variations may be made in the embodiments described by persons skilled in the art without departing from the scope of the invention as defined by the following claims. Moreover, no element and component in the present disclosure is intended to be dedicated to the public regardless of whether the element or component is explicitly recited in the following claims. Each of the terms “first” and “second” is only a nomenclature used to modify its corresponding element. These terms are not used to set up the upper limit or lower limit of the number of elements.

What is claimed is:

1. A near field communication built-in garment accessory, having a near field communication module (NFC module) located at a position of the garment accessory to communicate with an electronic device to transfer data between the electronic device and the NFC module and comprising a main body, a covering member to integrate with the main body and the NFC module positioned between a space created by integration of the main body and the covering member wherein the accessory is water proof; wherein the NFC module comprises a NFC chip and an antenna; the antenna is positioned surrounding the periphery of the space; the main body and the covering member are integrated by an adhesive or through high frequency welding; the NFC module has a memory and has a function of encryption to determine whether the data stored in the NFC is accessible or not.

2. The accessory as claimed in claim 1, wherein the accessory is one selected from the group consisting of the following or combination thereof: button, zipper head, patch, print, and embroidered sheet.

3. The accessory as claimed in claim 1, wherein the accessory is a button having a plurality of through-holes for sewing.

4. The accessory as claimed in claim 1, wherein the accessory is mounted to a garment by sewing, adhesion, thermal transfer.

5. The accessory as claimed in claim 1, wherein the memory stores data which include one item selected from the group consisting of the following or combination thereof: cloth care instruction, brand name authentication information, owner identification, contact information, medical care alert information, cloth size, production history, membership, and uniform resource locator (URL).

6. The accessory as claimed in claim 1, wherein the data are used by a method comprising the following steps:
providing an electronic device supporting near field communication or a near field communication reading electronic device;
having the accessory be approached to the electronic device within a distance less than 30 mm;
reading the data stored in the memory by the electronic device wherein the data include one item selected from the group consisting of the following or combination thereof: cloth care instruction, brand name authentication information, owner identification, contact information, medical care alert information, cloth size, production, history, membership, and uniform resource locator (URL);
processing the data by the electronic device through providing a process selection menu including choices of starting a lottery, reading cloth related information, going to a private URL and going to a public URL wherein the cloth related information includes one item selected from the group consisting of the following or combination thereof: cloth care instruction, brand name authentication information, owner identification, contact information, medical care alert information, cloth size, production history, membership.

7. The accessory as claimed in claim 6, wherein in the step of processing the data by the electronic device through providing the process selection menu, when the cloth related information selected in the process selection menu, the electronic device provides cloth related information options including showing cloth care instruction by displaying an image or a text message stored in the memory, authenticating the brand name by confirming the brand name authentication information via the internet, and showing the owner identification by directly displaying the owner identification or accessing the internet to retrieve data related to the owner identification which is stored in a preset cloud storage space.

8. The accessory as claimed in claim 5, wherein the owner identification, the contact information, or the medical care alert information is directly shown on a near field communication reader for emergency.

9. The accessory as claimed in claim 5, wherein the cloth size is inputted to a near field communication reader for inventory management.

10. A method for manipulating data stored in a near field communication built-in garment accessory, having a near field communication module (NFC module) located at a position of the garment accessory to communicate with an electronic device to transfer data between the electronic device and the NFC module and comprising a main body, a covering member to integrate with the main body and the NFC module positioned between a space created by integration of the main body and the covering member wherein the accessory is water proof; wherein the NFC module comprises a NFC chip and an antenna; the antenna is positioned surrounding the periphery of the space; the main body and the covering member are integrated by an adhesive or through high frequency welding; the NFC module has a memory and has a function of encryption to determine whether the data stored in the NFC is accessible or not, the method comprising the following steps:
providing an electronic device supporting near field communication or a near field communication reading electronic device;
having the near field communication built-in garment accessory be approached to the electronic device within a distance less than 30 mm;
reading data stored in the near field communication built-in garment accessory by the electronic device wherein the data include one item selected from the group consisting of the following or combination thereof: cloth care instruction, brand name authentication information, owner identification, contact information, medical care alert information, cloth size, production history, membership, and uniform resource locator (URL); and
processing the data by the electronic device through providing a process selection menu including choices of starting a lottery, reading cloth related information, going to a private URL and going to a public URL wherein the cloth related information includes one item selected from the group consisting of the following or combination thereof: cloth care instruction, brand name authentication information, owner identification, contact information, medical care alert information, cloth size, production history, membership.

11. The method as claimed in claim 10, when the choice of starting a lottery in the process selection menu is selected, the method further comprising:
pressing a spinner button to receive a discount percentage, a gift, a discount coupon, a membership cumulative point, or other perks by conducting a probability experiment.

12. The method as claimed in claim 10, when the choice of reading cloth related information in the process selection menu is selected, the method further comprising:
displaying an image or a text message stored in the memory.

13. The method as claimed in claim 10, when the choice of showing owner identification in the process selection menu is selected, the method further comprising:
directly displaying the owner identification or accessing the interne to retrieve data related to the owner identification which is stored in a preset cloud storage space.

14. The method as claimed in claim 10, when the choice of going to a private URL or a public URL in the process selection menu is selected, the method further comprising:
using the uniform resource locator (URL) stored in the memory to navigate a web site via the interne.

15. The method as claimed in claim 14, wherein a prerecorded video or message is displayed by going to the private URL and an online shopping store or an open access video is displayed by going to the public URL.

16. The method as claimed in claim 14, wherein the online shopping store displays goods based on information from the owner identification, the membership or the brand name stored in the memory of the accessory or displays cloths which are possibly matched to the accessory.
